(19) United States
(12) Patent Application Publication
(10) Pub. No.: US 2018/0078979 A1
(43) Pub. Date: Mar. 22, 2018

(54) DUCT CANISTER AND AXIAL FAN

(71) Applicant: AIR SYSTEMS, INC. d.b.a. AIR SYSTEMS INTERNATIONAL, INC., Chesapeake, VA (US)

(72) Inventor: Lawrence Shane Intravatola, Chesapeake, VA (US)

(21) Appl. No.: 15/711,813

(22) Filed: Sep. 21, 2017

Related U.S. Application Data
(60) Provisional application No. 62/398,129, filed on Sep. 22, 2016.

(51) Int. Cl. B08B 15/00; F24F 7/06; F24F 13/02

(52) U.S. Cl. CPC B08B 15/002; A47L 9/1683; F24F 13/0218; F24F 7/06

(57) ABSTRACT

A duct canister for attachment to an axial fan includes a canister body having a first end with a first opening, a second end with a second opening, and a side wall extending between the first end and the second end of the canister body. The canister body includes an enclosed space defined by an interior surface of the side wall in which a duct is selectively stored for later extension and use. The second opening at the second end of the canister body is selectively covered by a cover member. A hinge assembly attaches the cover member to the second end of the canister body in a manner allowing one to selectively pivot the cover member between a closed configuration with the cover member fully covering the second opening and an opened configuration, wherein the opened configuration includes rotating the cover member 90 degrees from the closed configuration so as to open the second opening or rotating the cover member 180 degrees to a position beneath the canister body.

### CROSS REFERENCE TO RELATED APPLICATION

This application claims the benefit of U.S. Provisional Patent Application Ser. No. 62/398,129, entitled “DUCT CANISTER AND AXIAL FAN,” filed Sep. 22, 2016.

### BACKGROUND OF THE INVENTION

### 1. Field of the Invention

The present invention generally relates to ventilation systems. In particular, the invention relates to a portable duct canister for use at various locations.

### 2. Description of the Related Art

Tanks, sewers, and other enclosures that workmen must enter periodically require air ventilation systems for the men working in the enclosures. Without some type of air ventilation the workers would be required to wear respirators. Often, the work location is remote from truck access and it is necessary to carry the ventilation equipment to a work site.

One problem that arises concerns how to transport ducts to a remote location while controlling the length of duct that will ultimately be used in accessing the enclosure. In addition, problems arise concerning the mechanisms for attaching the fans to the extended duct. The present invention provides a duct canister assisting with this continuing need.

### SUMMARY OF THE INVENTION

It is, therefore, an object of the present invention to provide a duct canister for attachment to an axial fan including a canister body having a first end with a first opening, a second end with a second opening, and a side wall extending between the first end and the second end of the canister body. The canister body includes an enclosed space defined by an interior surface of the side wall in which a duct is selectively stored for later extension and use. The second opening at the second end of the canister body is selectively covered by a cover member. A hinge assembly attaches the cover member to the second end of the canister body in a manner allowing one to selectively pivot the cover member between a closed configuration with the cover member fully covering the second opening and an opened configuration, wherein the opened configuration includes rotating the cover member 90 degrees from the closed configuration so as to open the second opening or rotating the cover member 180 degrees to a position beneath the canister body.

It is also an object of the present invention to provide a duct canister wherein the canister body has a cylindrical shape.

It is another object of the present invention to provide a duct canister wherein the interior surface is substantially smooth and follows the cylindrical shape of the canister body.

It is a further object of the present invention to provide a duct canister wherein the first opening is not covered.

It is also an object of the present invention to provide a duct canister wherein the cover member is a substantially disk-shaped member.

It is another object of the present invention to provide a duct canister wherein the cover member includes a disk-shaped cover body having a circumferential edge from which an edge member extends so as to define a cavity shaped and dimensioned for positioning over the second end of the canister body.

It is a further object of the present invention to provide a duct canister wherein an internal diameter of the cover member is slightly larger than an external diameter of the canister body at the second end of the canister body such that when the cover member is positioned to cover the second opening, the edge member covers an exterior surface of the canister body adjacent to the second end of the canister body.

It is also an object of the present invention to provide a duct canister wherein the hinge assembly includes a body flange of the canister body and a cover flange of the cover member secured together via a pivot pin extending between the body flange and the cover flange.

It is another object of the present invention to provide a duct canister wherein the body flange functions as a support leg maintaining the second end of the canister body off of the ground when the duct is in use and enhances stability of the duct canister and an axial fan when in use.

It is a further object of the present invention to provide a duct canister wherein the body flange includes first and second outwardly extending side walls which are connected at their free ends by a base wall.

It is also an object of the present invention to provide a duct canister wherein the first and second outwardly extending side walls are substantially parallel to each other while the base wall is substantially perpendicular to each of the first and second outwardly extending side walls.

It is another object of the present invention to provide a duct canister wherein the body flange extends outwardly from an exterior surface of the canister body and the base wall is a radial distance D from a smallest diameter portion of the canister body along the exterior surface of the canister body when measured along a line normal to the exterior surface.

It is a further object of the present invention to provide a duct canister wherein the first end of the canister body is provided with a circumferentially oriented rim that extends outwardly from the smallest diameter portion of the canister body along the exterior surface of the canister body the radial distance D from the smallest diameter portion of the canister body along the exterior surface of the canister body when measured along a line normal to the exterior surface, such that with the base wall and the circumferentially oriented rim both extending beyond the smallest diameter portion of the canister body by the radial distance D. As a result, the canister body will sit above a support surface by a distance D when the duct canister is laid upon a support surface and positioned for use with the base wall and the circumferentially oriented rim sitting upon a support surface.

It is also an object of the present invention to provide a duct canister wherein the body flange also includes a longitudinal axis that is parallel to the longitudinal axis of the canister body such that the body flange includes a first end and a second end. The first end of the body flange is located at the second end of the canister body and in alignment with the second opening of the canister body, while the second end of the body flange is spaced from the second opening and closer to the first end of the canister body. The base wall of the body flange is removed in an area adjacent to the first end of the body flange allowing for free movement of the cover flange as the cover member is moved between its closed configuration and its opened configuration.

It is another object of the present invention to provide a duct canister wherein the duct canister is constructed from a rigid plastic material.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1A is a perspective view of a generic axial fan and duct canister in accordance with the present invention.

FIG. 1B is a perspective view of a preferred axial fan for use in accordance with the present invention.

FIG. 2 is a perspective view of the duct canister in its storage orientation. FIG. 3 is a perspective view of the duct canister from a direction opposite that shown in FIG. 2.

FIG. 4 is a detailed view showing the lid open. FIG. 5 is an exploded view of the lid assembly. FIG. 6 is a cross sectional view of the duct canister in its storage orientation. FIG. 7 is a cross sectional view of the duct canister in its extended orientation.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

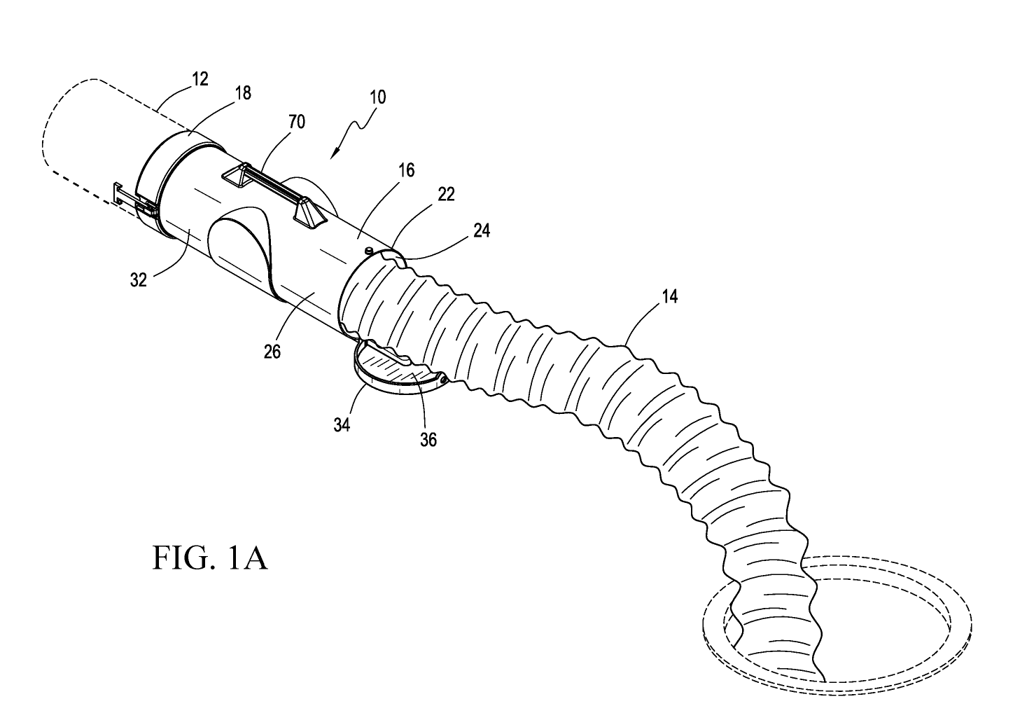

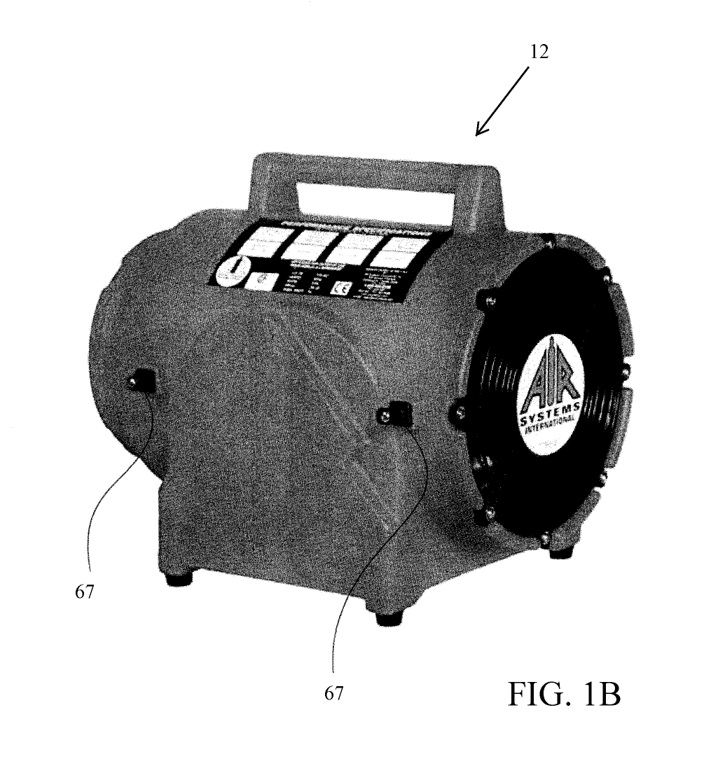

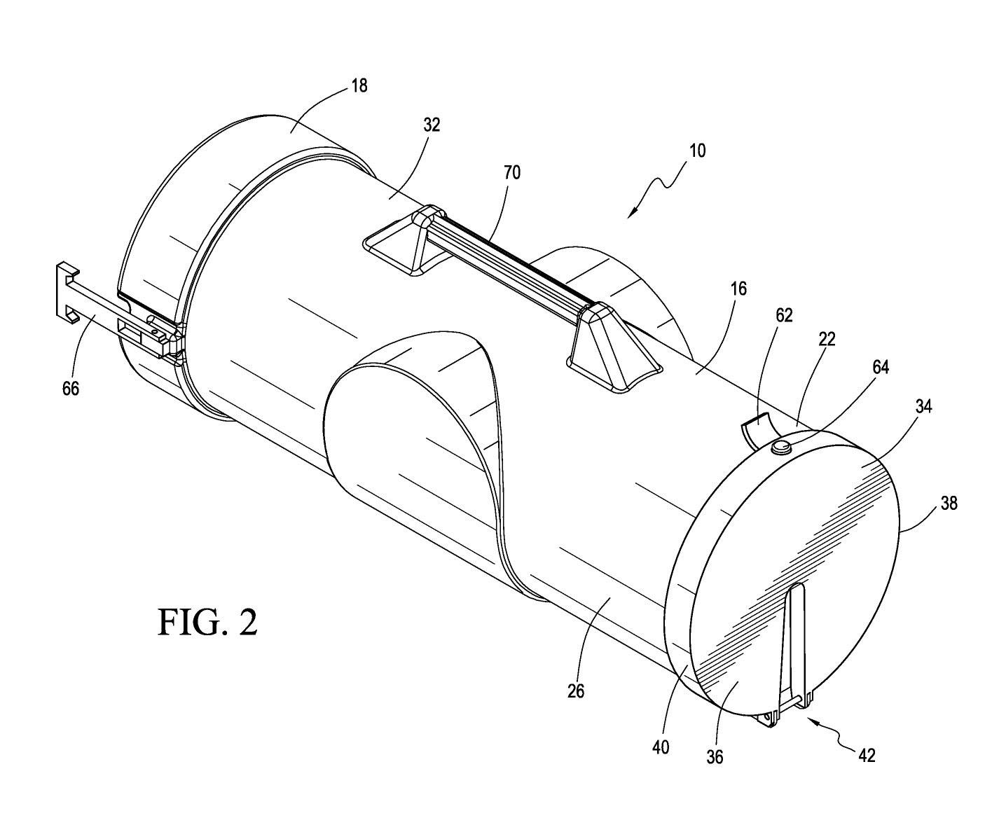

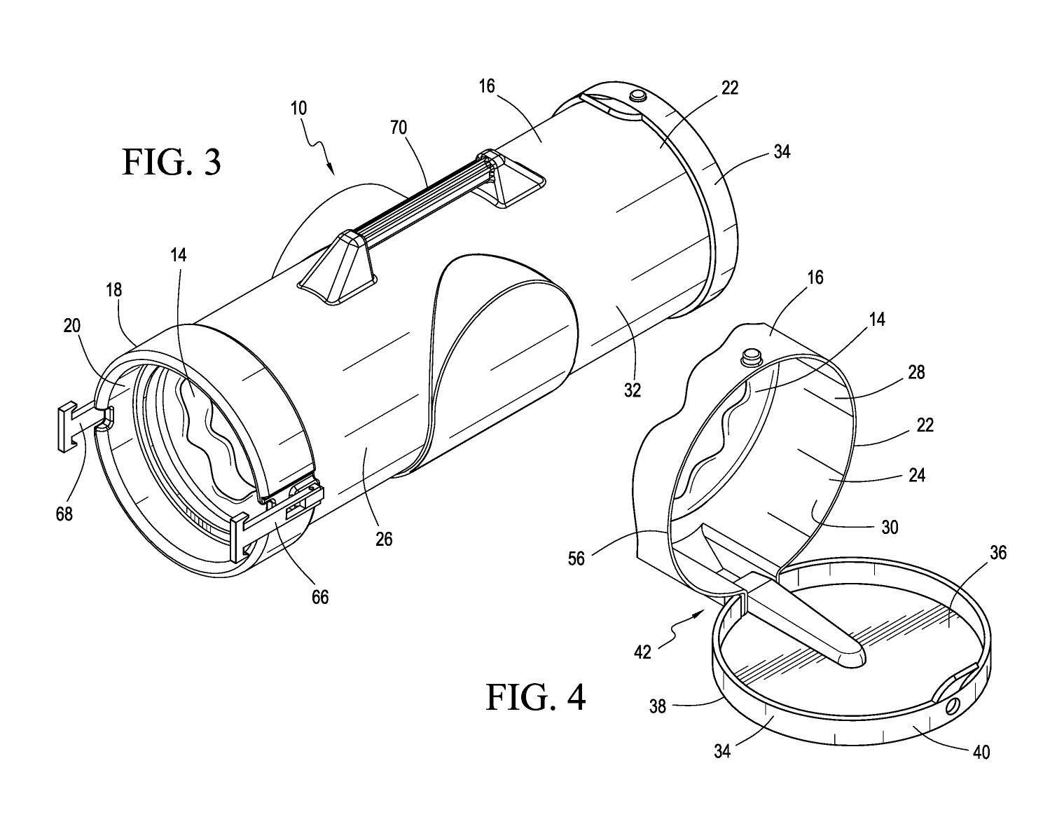

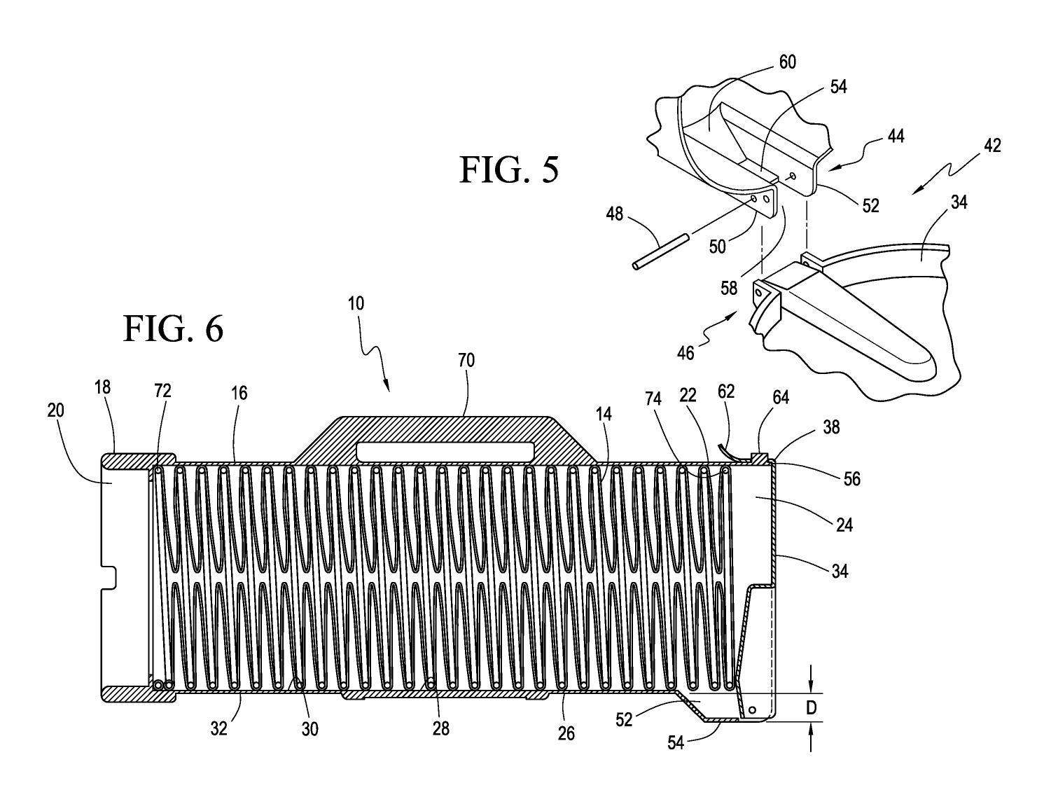

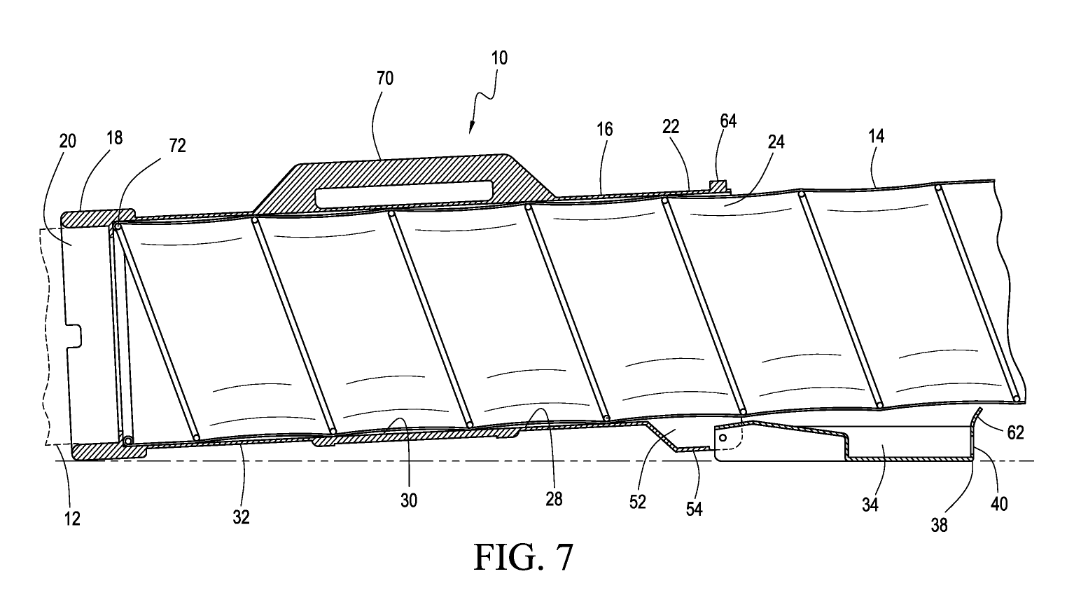

With reference to FIGS. 1 to 7, a duct canister 10 is disclosed. As will be appreciated based upon the following disclosure, the duct canister 10 is shaped and dimensioned for attachment to an axial fan 12 (it is appreciated axial blower, cylindrical axial fan, etc. are all terms used to describe fans that may be used in accordance with the present invention) while the opposite end thereof is opened to allow for the retrieval and extension of duct 14 stored within the duct canister 10. The alignment of the axial fan 12 with the duct 14 provides for a highly stable assembly providing for efficient air flow. The ducts 14 used in conjunction with the present invention are conventional extendable and flexible ducts.

The duct canister 10 is preferably constructed from a rigid plastic material or similar material. In accordance with a preferred embodiment, the material is polyethylene or a conductive or antistatic material (e.g., ICORENE®, that is, a plastic commonly used in manufacturing processes). The duct canister 10 is shaped and dimensioned for the storage and retrieval of an elongated, flexible and compressible length of duct 14 contained therein.

The duct canister 10 has the general shape of an elongated cylinder. As such, the duct canister 10 includes a canister body 16 having a first end 18 with a first opening 20, a second end 22 with a second opening 24, and side wall(s) 26 extending between the first end 18 and the second end 22 of the canister body 16. The canister body 16 includes an enclosed space 28 in which the duct 14 may be selectively stored for later extension and use. The enclosed space 28 is defined by the interior surface 30 of the side wall(s) 26. In accordance with a preferred embodiment, the interior surface 30 is substantially smooth and follows the cylindrical shape of the canister body 16. The canister body 16 also includes an exterior surface 32 which follows the cylindrical shape of the canister body 16.

While the first opening 20 is not covered in accordance with a preferred embodiment of the present invention, the second opening 24 at the second end 22 of the canister body 16 is selectively covered by a cover member 34. The cover member 34 is a substantially disk-shaped member including a disk-shaped cover body 36 having a circumferential edge 38 from which an edge member 40 extends so as to define a cavity shaped and dimensioned for positioning over the second end 22. As such, the internal diameter of the cover member 34 is slightly larger than the external diameter of the canister body 16 at the second end 22 thereof. When the cover member 34 is positioned to cover the second opening 24, the edge member 40 covers the exterior surface 32 of the canister body 16 adjacent the second end 22 thereof.

Attachment of the cover member 34 to the second end 22 of the canister body 16 is achieved by the provision of a hinge assembly 42. The hinge assembly 42 connects the cover member 34 to the second end 22 of the canister body 16 in a manner allowing one to selectively pivot the cover member 34 between a closed configuration with the cover member 34 fully covering the second opening 24 and an opened configuration with the cover member 34 rotated 90 degrees from the closed configuration so as to open the second opening 24 and allow for complete access to the duct 14 contained therein. Alternatively, the cover member 34 may rotate at 180 degrees to be beneath the canister body 16.

The hinge assembly 42 includes a body flange 44 and a cover flange 46 secured together via a pivot pin 48 extending between the body flange 44 and the cover flange 46. As will be appreciated based upon the following disclosure, the body flange 44, in addition to being shaped to function in conjunction with the cover flange 46 and the pivot pin 48 for the selective rotation of the cover member 34 between the closed configuration and the opened configuration(s), functions as a support leg maintaining the second end 22 off of the ground when the duct 14 is in use. The body flange 44 also enhances the stability of the duct canister 10 and axial fan 12 system when in use. In particular, when the latching members 66, 68 are secured to the latch engagement elements 67 of the axial fan 12, the duct canister 10 and axial fan 12 are fully aligned such that the cover member 34 sits on the ground in a manner enhancing the overall stability of the system. The body flange 44 and the cover member 34 facilitate proper and easy connection of the duct canister 10 to the axial fan 12. Likewise, the alignment of the latching members 66, 68 and the latch engagement elements 67 of the axial fan 12 assists in properly placing the body flange 44 in a stable position engaged with the support surface. Therefore, body flange 44, latching members 66, 68, and latch engagement elements 67, and cover member 34 provide for stability, ease of use, and connection.

The body flange 44 includes first and second outwardly extending side walls 50, 52 which are connected at their free end by a base wall 54. The first and second outwardly extending side walls 50, 52 are substantially parallel to each other while the base wall 54 is substantially perpendicular to each of the first and second outwardly extending side walls 50, 52. The body flange 44 extends outwardly from the exterior surface 32 of the canister body 16 and the base wall 54 is therefore a radial distance D from the smallest diameter of the canister body 16 along the exterior surface 32 of the canister body 16 when measured along a line normal to the exterior surface 32. With this in mind, the first end 18 of the canister body 16 is provided with a circumferentially oriented rim 56 that extends outwardly from the smallest diameter portion of the canister body 16 along the exterior surface 32 of the canister body 16 a radial distance D from the smallest diameter portion of the canister body 16 along the exterior surface 32 of the canister body 16 when measured along a line normal to the exterior surface 32. With the base wall 54 and the circumferentially oriented rim 56 both extending beyond the smallest diameter of the canister body 16 by a distance D, the canister body 16 will sit above a supporting surface by a distance D when the duct canister 10 is laid upon the support surface and positioned for use with the base wall 54 and the circumferentially oriented rim 56 sitting upon the support surface.

The body flange 44 also includes a longitudinal axis that is parallel to the longitudinal axis of the canister body 16. Considering the body flange 44 as it extends along the longitudinal axis, the body flange 44 includes a first end 58 and a second end 60. The first end 58 of the body flange 44 is located at the second end 22 of the canister body 16 and in alignment with the second opening 24 of the canister body 16, while the second end 60 of the body flange 44 is spaced from the second opening 24 and closer to the first end 18 of the canister body 16. With this in mind, the base wall 54 of the body flange 44 is removed in the area adjacent the first end 58 of the body flange 44. The removal of a portion of the base wall 54 in this area allows for free movement of the cover flange 46 as the cover member 34 is moved between its closed configuration and its opened configuration.

In particular, the first and second side walls 50, 52 of the body flange 44 are spaced a distance such that the cover flange 46 can be positioned between the first and second side walls 50, 52 with the cover flange 46 not extending beyond the space defined by the base wall 54 and the first and second side walls 50, 52. Attachment of the cover flange to the first and second side walls 50, 52 of the body flange 44 is achieved by forming holes through the respective cover flange 46 and the first and second side walls 50, 52, and passing a pivot pin 48 therethrough.

As mentioned above, the base wall 54 of the body flange 44 is removed in the area adjacent the first end 58 of the body flange 44 to allow for free rotation of the cover member 34. That is, the base wall 54 is shaped to allow for rotation of the portion of the cover flange 46 extending distal to the pivot pin 48. In addition, the positioning of the pivot pin 48 is such that the cover member 34 may lie substantially flat on the ground when it is moved to its opened configuration without interfering with the withdrawal of the duct 14 from within the canister body 16.

Controlled movement of the cover member 34 between the closed configuration and the opened configuration is achieved by the provision of a cover handle 62 and a friction latch 64 at a position diametrically opposed from the cover flange 46. The cover handle 62 extends from the edge member 40 of the cover member 34 such that it may be readily engaged by the hand of a user desiring to make use of the present duct canister 10. Secure closure of the cover member 34 when in its closed configuration is facilitated by the provision of a projection 64 along the exterior of the canister body 16 that engages with the underside of the handle 62 when the cover member 34 is closed.

As briefly mentioned above, the first end 18 of the canister body 16 is open providing free access to the duct 14 contained therein. The first end 18 is shaped and dimensioned for attachment of an axial fan 12 thereto. With this in mind, the first opening 20 is of such a shape that an axial fan 12 may be connected to the duct canister 10 for creation of a continuous air flow conduit to a confined space or area to be treated. Controlled insertion is facilitated by the provision of an abutment ridge 67 along the interior surface 30 adjacent the first end 18. Attachment is further facilitated by the provision of latching members 66, 68 along the exterior surface 32 of the canister body 16. The latching members 66, 68 are pivotally secured to the exterior surface 32 of the canister body 16 at diametrically opposed positions and are shaped and dimensioned for engagement with the axial fan 12 to be used in conjunction with the canister body 16.

In order to provide for ideal positioning of the duct canister 10 and the axial fan 12, the latching members 66, 68 are positioned at 3 o'clock and 9 o'clock along the circumference of the canister body 16. That is, and if one considers the location at which the body flange 44 is located to be the bottom of the duct canister 10, the latching members 66, 68 are located at 90 degrees from the bottom in both a clockwise direction and a counterclockwise direction. In addition to the latching members 66, 68, the canister body 16 is provided with a centrally located handle 70 that is positioned along the exterior surface 32 of the canister body 16 at a position approximately 180 degrees from the bottom of the duct canister 10.

As briefly mentioned above, the duct canister 10 includes a compressible, flexible and extendable duct 14 stored therein. The duct 14 is adapted for selective retrieval and extension through the second opening 24 at the second end 22 of the duct canister 10. Referring to FIG. 6, the duct 14 is depicted in a compressed form, with a first end (not shown) of the duct 14 secured within the canister body 16 adjacent the first end 18 of the canister body 16 and the second end 74 of the duct 14 in contact with the cover member 34 selectively covering the second end 22 of the duct canister 10.

In practice, the duct canister 10 is employed as follows. The duct canister 10 is carried to a desired location and the duct canister 10 is laid upon the ground with the base wall 54 of the body flange 44 and the rim 56 in contact with the ground. The axial fan 12 is then secured to the first end 18 of the canister body 16 with the latching members 66, 68 extending between the first end 18 of the canister body 16 and the axial fan 12. Thereafter, the cover member 34 is rotated from its closed configuration to its opened configuration to expose the duct 14, which is then withdrawn from the duct canister 10 and positioned as desired.

While the preferred embodiments have been shown and described, it will be understood that there is no intent to limit the invention by such disclosure, but rather, it is intended to cover all modifications and alternate constructions falling within the spirit and scope of the invention.

1. A duct canister for attachment to an axial fan, comprising:
a canister body having a first end with a first opening, a second end with a second opening, and a side wall extending between the first end and the second end of the canister body, the canister body includes an enclosed space defined by an interior surface of the side wall in which a duct is selectively stored for later extension and use;
the second opening at the second end of the canister body is selectively covered by a cover member, a hinge assembly attaches the cover member to the second end of the canister body in a manner allowing one to selectively pivot the cover member between a closed configuration with the cover member fully covering the second opening and an opened configuration, wherein the opened configuration includes rotating the cover member 90 degrees from the closed configuration so as to open the second opening or rotating the cover member 180 degrees to a position beneath the canister body.

2. The duct canister according to claim 1, wherein the canister body has a cylindrical shape.

3. The duct canister according to claim 2, wherein the interior surface is substantially smooth and follows the cylindrical shape of the canister body.

4. The duct canister according to claim 1, wherein the first opening is not covered.

5. The duct canister according to claim 4, wherein the cover member is a substantially disk-shaped member.

6. The duct canister according to claim 4, wherein the cover member includes a disk-shaped cover body having a circumferential edge from which an edge member extends so as to define a cavity shaped and dimensioned for positioning over the second end of the canister body.

7. The duct canister according to claim 6, wherein an internal diameter of the cover member is slightly larger than an external diameter of the canister body at the second end of the canister body such that when the cover member is positioned to cover the second opening, the edge member covers an exterior surface of the canister body adjacent the second end of the canister body.

8. The duct canister according to claim 1, wherein the hinge assembly includes a body flange of the canister body and a cover flange of the cover member secured together via a pivot pin extending between the body flange and the cover flange.

9. The duct canister according to claim 8, wherein the body flange functions as a support leg maintaining the second end of the canister body off of the ground when the duct is in use and enhances stability of the duct canister and an axial fan when in use.

10. The duct canister according to claim 8, wherein the body flange includes first and second outwardly extending side walls which are connected at their free ends by a base wall.

11. The duct canister according to claim 10, wherein the first and second outwardly extending side walls are substantially parallel to each other while the base wall is substantially perpendicular to each of the first and second outwardly extending side walls.

12. The duct canister according to claim 10, wherein the body flange extends outwardly from an exterior surface of the canister body and the base wall is a radial distance D from a smallest diameter portion of the canister body along the exterior surface of the canister body when measured along a line normal to the exterior surface.

13. The duct canister according to claim 12, wherein the first end of the canister body is provided with a circumferentially oriented rim that extends outwardly from the smallest diameter portion of the canister body along the exterior surface of the canister body the radial distance D from the smallest diameter portion of the canister body along the exterior surface of the canister body when measured along a line normal to the exterior surface, such that with the base wall and the circumferentially oriented rim both extending beyond the smallest diameter portion of the canister body by the radial distance D, the canister body will sit above a support surface by a distance D when the duct canister is laid upon a support surface and positioned for use with the base wall and the circumferentially oriented rim sitting upon a support surface.

14. The duct canister according to claim 10, wherein the body flange also includes a longitudinal axis that is parallel to the longitudinal axis of the canister body such that the body flange includes a first end and a second end, the first end of the body flange is located at the second end of the canister body and in alignment with the second opening of the canister body, while the second end of the body flange is spaced from the second opening and closer to the first end of the canister body, wherein the base wall of the body flange is removed in an area adjacent the first end of the body flange allowing for free movement of the cover flange as the cover member is moved between its closed configuration and its opened configuration.

15. The duct canister according to claim 1, wherein the duct canister is constructed from a rigid plastic material.
